(19) United States
(12) Patent Application Publication
(10) Pub. No.: US 2026/0281802 A1
(43) Pub. Date: Sep. 17, 2026

(54) SERVICE DATA FLOW PROCESSING METHOD AND APPARATUS, COMPUTER-READABLE MEDIUM, AND DEVICE

(71) Applicant: TENCENT TECHNOLOGY (SHENZHEN) COMPANY LIMITED, Shenzhen (CN)

(72) Inventors: Yixue LEI, Shenzhen (CN); Yuhang JIA, Shenzhen (CN)

(73) Assignee: TENCENT TECHNOLOGY (SHENZHEN) COMPANY LIMITED, Shenzhen (CN)

(21) Appl. No.: 19/674,550

(22) Filed: May 12, 2026

Related U.S. Application Data
(63) Continuation of application No. PCT/CN2025/111071, filed on Jul. 29, 2025.

(30) Foreign Application Priority Data
Aug. 1, 2024 (CN) 202411053106.8

(51) Int. Cl. H04W 28/02; H04L 41/0894

(52) U.S. Cl. CPC H04W 28/0268; H04L 41/0894

(57) ABSTRACT

A service data flow processing method, apparatus, and computer-readable storage medium for synchronized multi-flow transmission management. The method determines that multiple service data flows must meet synchronization requirements specifying that transmission delays remain within defined delay ranges. Based on these requirements, processing policy information is generated containing policies for configuring quality of service processing-related information to enable transmission synchronization across the flows. This processing policy information is transmitted to a session management entity, which configures the QoS processing-related information at processing devices handling the service data flows. This approach enables coordinated delivery of related data streams through centralized policy management and distributed QoS configuration across network infrastructure.

### CROSS-REFERENCE TO RELATED APPLICATIONS

This application is a continuation application of International Application No. PCT/CN2025/111071 filed on Jul. 29, 2025 which claims priority to Chinese Patent Application No. 202411053106.8, filed with the China National Intellectual Property Administration on Aug. 1, 2024, the disclosures of each being incorporated by reference herein in their entireties.

### FIELD

The disclosure relates to the field of computers and communication technologies, a service data flow processing method and apparatus, a computer-readable medium, and a device.

### BACKGROUND

In 5^{th}-generation (5G) and subsequent evolved systems (such as 5G-advanced (5G-A) and 6G), high-bandwidth interactive services are important service types, such as cloud gaming, virtual reality (VR), augmented reality (AR), mixed reality (MR), extended reality (XR), cinematic reality (CR), and XR and media services (XRM).

These high-bandwidth interactive services have a stringent requirement on transmission timeliness, and service flows of this type of services usually include a plurality of media types, such as audio, video, haptic, or other media types. During transmission, service flows of different media types may be mapped to different quality of service (QoS) flows, and different QoS flows may experience different time delays during transmission. This may cause a problem that service data of different media types is not synchronized when a receiving end generates, based on received service flows of the plurality of media types, media content for playing.

### SUMMARY

Provided are a service data flow processing method and apparatus, a device, a storage medium, and a program product, which can implement synchronized multi-flow transmission through policy-based quality of service configuration and delay coordination across service data flows.

According to some embodiments, a service data flow processing method, performed by an electronic device, includes: determining that a plurality of service data flows are to meet a synchronization requirement during transmission, wherein the synchronization requirement specifies that transmission delays of the plurality of service data flows are kept within a delay range; generating, based on the synchronization requirement, processing policy information corresponding to the plurality of service data flows, wherein the processing policy information provides a first policy for configuring first quality of service (QoS) processing-related information for transmission synchronization of the plurality of service data flows; and transmitting the processing policy information to a session management entity, to cause the session management entity to configure, based on the processing policy information, the first QoS processing-related information at a processing device of the plurality of service data flows.

According to some embodiments, a service data flow processing apparatus, includes: at least one memory configured to store program code; and at least one processor configured to read the program code and operate as instructed by the program code, the program code including: determination code configured to cause at least one of the at least one processor to determine that a plurality of service data flows are to meet a synchronization requirement during transmission, wherein the synchronization requirement specifies that transmission delays of the plurality of service data flows are kept within a delay range; generation code configured to cause at least one of the at least one processor to generate, based on the synchronization requirement, processing policy information corresponding to the plurality of service data flows, wherein the processing policy information provides a first policy for configuring first quality of service (QoS) processing-related information for transmission synchronization of the plurality of service data flows; and transmission code configured to cause at least one of the at least one processor to transmit the processing policy information to a session management entity, to cause the session management entity to configure, based on the processing policy information, the first QoS processing-related information at a processing device of the plurality of service data flows.

According to some embodiments, a non-transitory computer-readable storage medium, storing computer code which, when executed by at least one processor, causes the at least one processor to at least: determine that a plurality of service data flows are to meet a synchronization requirement during transmission, wherein the synchronization requirement specifies that transmission delays of the plurality of service data flows are kept within a delay range; generate, based on the synchronization requirement, processing policy information corresponding to the plurality of service data flows, wherein the processing policy information provides a first policy for configuring first quality of service (QoS) processing-related information for transmission synchronization of the plurality of service data flows; and transmit the processing policy information to a session management entity, to cause the session management entity to configure, based on the processing policy information, the first QoS processing-related information at a processing device of the plurality of service data flows.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture to which a technical solution in some embodiments may be applied.

FIG. 2 is a schematic diagram of a transmission process of a multimedia packet according to some embodiments.

FIG. 3 is a schematic diagram of performing data transmission by using a plurality of QoS flows according to some embodiments.

FIG. 4 is a flowchart of a service data flow processing method according to some embodiments.

FIG. 5 is a schematic diagram of an architecture of a key network element of a 5G network.

FIG. 6 is a flowchart of a service data flow processing method according to some embodiments.

FIG. 7 is a flowchart of a service data flow processing method according to some embodiments.

FIG. 8 is a flowchart of a service data flow processing method according to some embodiments.

FIG. 9 is a flowchart of a service data flow processing method according to some embodiments.

FIG. 10 is a flowchart of a service data flow processing method according to some embodiments.

FIG. 11 is a block diagram of a service data flow processing apparatus according to some embodiments.

FIG. 12 is a block diagram of a service data flow processing apparatus according to some embodiments.

FIG. 13 is a schematic structural diagram of a computer system for implementing an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Exemplary implementations are described more comprehensively with reference to accompanying drawings. However, the exemplary implementations may be implemented in a plurality of forms, and are not to be construed as being limited to these examples.

In addition, features, structures, or characteristics described in this application may be combined in one or more embodiments in any proper mode. In the following description, there are many details to fully understand embodiments of this application. However, a person skilled in the art is to be aware that, when implementing technical solutions in this application, not all detailed features in the embodiments may be used, one or more details may be omitted, or another method, element, apparatus, operation, or the like may be used.

In the embodiments of this application, a term “module” or “unit” refers to a computer program or a part of a computer program having a predetermined function, and operates together with other relevant parts to achieve a predetermined objective, and may be completely or partially implemented by using software, hardware (such as a processing circuit or a memory), or a combination of software and hardware. Similarly, one processor (or a plurality of processor or memories) may be configured to implement one or more modules or units. In addition, each module or unit may be a part of an overall module or unit including the module or unit function.

The block diagrams shown in the accompanying drawings are merely functional entities and do not necessarily correspond to physically independent entities. For example, these functional entities may be implemented in a form of software, or these functional entities may be implemented in one or more hardware modules or integrated circuits, or these functional entities may be implemented in different networks and/or processor apparatuses and/or micro-controller apparatuses.

The flowcharts shown in the accompanying drawings are merely exemplary descriptions, and do not necessarily include all content and operations/blocks, nor do not have to be executed in described order. For example, some operations/operations may further be decomposed, but some operations/operations may be merged or partially merged. Therefore, actual execution order may change according to an actual case.

“A plurality of” mentioned herein means two or more. “And/or” describes an associative relationship between associated objects, indicating that three relationships may exist. For example, A and/or B may indicate: presence of A alone, presence of both A and B, and presence of B alone. Character “/” generally denotes an “or” relationship between the associated objects.

With the development of 5G and subsequent evolved systems (such as 5G-A and 6G), many multimedia services that require a large volume of data and a short delay are applied. For example, interactive services such as a cloud gaming service, VR, AR, MR, XR, or CR.

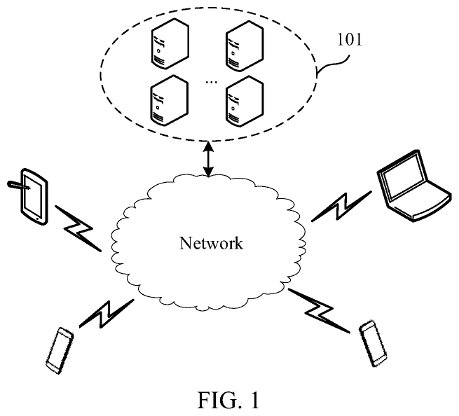

For example, in a cloud gaming scenario shown in FIG. 1, a cloud server 101 is configured to run cloud gaming. The cloud server 101 may render a game picture, encode an audio signal and a rendered image, and finally transmit encoded data obtained by encoding to each game client by using a network. The game client may be a user equipment (UE) having a streaming media playback capability, a human-computer interaction capability, a communication capability, and the like, such as a smartphone, a tablet computer, a notebook computer, a desktop computer, a smart television, a smart household, an in-vehicle terminal, an aircraft, or a head-mounted device. In some embodiments, the game client may be an application running in a terminal device. For example, the game client may decode the encoded data transmitted by the cloud server 101, to obtain an analog audio and video signal, and play the analog audio and video signal.

FIG. 1 merely exemplarily represents a system architecture of a cloud gaming system, and does not limit a architecture of the cloud gaming system. For example, in another embodiment, the cloud gaming system may further include a background server for scheduling, and the like. In addition, the cloud server 101 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a cloud computing service such as big data and an artificial intelligence platform. The game client and the cloud server 101 may be directly or indirectly connected to each other in a wired or wireless communication mode. This is not limited in this application herein.

In the foregoing multimedia-based interactive service application scenarios, even a single multimedia service frame or a group of packets (GoP) may have a large quantity of bytes. Therefore, during transmission, the single multimedia service frame or the GoP may be split into a plurality of packets for transmission.

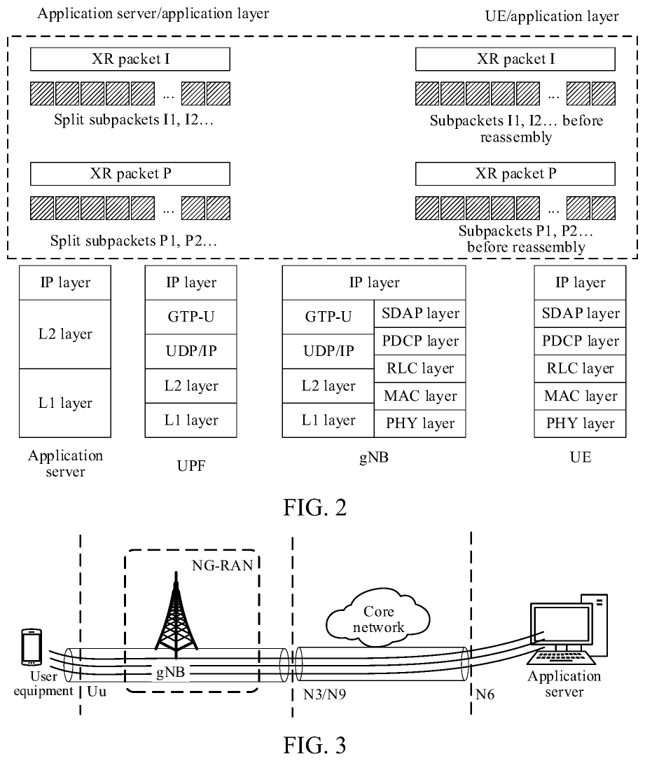

Specifically, as shown in FIG. 2, a 5G system is used as an example. The 5G communication network usually includes a core network (CN), a radio access network (RAN), a transmission network, a UE, an application layer, and the like.

The RAN is responsible for connecting the UE to a network (for example, the Internet) and processing data transmission. The RAN may include a next-generation NodeB (gNB).

For example, the CN includes a user plane function (UPF), an access and mobility management function (AMF), a session management function (SMF), a policy control function (PCF), a network exposure function (NEF), and a unified data management (UDM).

The UPF is responsible for processing data transmission between a UE and a network, including packet forwarding, routing, and QoS management. The UPF is further responsible for processing functions such as encryption and decryption of a packet. The AMF is responsible for processing access to a UE, mobility management, and session management. The AMF is responsible for authentication, authorization, and key management with the UE, and is further responsible for processing functions such as location update of the UE, and session establishment and release. The SMF is responsible for managing a data transmission session of a UE, including session establishment, maintenance, and release. The SMF is further responsible for managing a data transmission policy, to ensure high efficiency and reliability of data transmission. The PCF provides access and mobility policy control and session management policy control. The UDM is responsible for unified management of user data, including a user identity, subscription information, authentication data, and the like. The UDM is a central storage and management point of the user data in a 5G network.

As shown in FIG. 2, a user plane includes, for example, an application server (AS), a UPF, a gNB, and a UE. The user plane is responsible for transmission of user data. For some service scenarios, a multimedia packet may be transmitted in a downlink direction, for example, from an AS to a UPF, and then is transmitted to a UE by using a gNB. During transmission, the multimedia packet (using XR packets I and P as an example in FIG. 2) are split at an application layer of the AS. After split subpackets (subpackets I1, I2 . . . and subpackets P1, P2 . . . ) arrives at the UPF from the AS as Internet protocol (IP) packets, the 5G system transmits the subpackets to a UE end by using a protocol data unit (PDU) session. At the UE end, the subpackets are passed up through a protocol stack level by level, and reassembled to recover the multimedia packet. The protocol stack at the UE end includes, from bottom to top, a PHY layer, a media access control (MAC) layer, a radio link control (RLC) layer, a packet data convergence protocol (PDCP) layer, a service data adaptation protocol (SDAP) layer, and an IP layer.

In a system shown in FIG. 2, an L1 layer refers to a physical layer, and is configured to ensure that original data can be transmitted on various physical media. An L2 layer refers to a data link layer, and the data link layer provides a service for a network layer based on a service provided by the physical layer. An IP layer is the network layer, and is configured to implement data transmission between two end systems. UDP is a user datagram protocol. GTP-U refers to a general packet radio service (GPRS) tunneling protocol user plane. PHY is short for physical, and refers to a physical layer. MAC is media access control; and the RLC is radio link control, that is, a radio link control layer protocol. PDCP is a packet data convergence protocol. SDAP is a service data adaptation protocol.

As described above, for a multimedia service (such as an XRM service), it is common to transmit one frame of multimedia data by using a plurality of packets. Data formed by a single multimedia service frame or a GoP may be carried by a series of IP packets. A correlation exists between these IP packets, and processing these IP packets based on the correlation can effectively save a wireless network bandwidth. For example, it is assumed that transmission is performed by using a plurality of IP packets, and the plurality of IP packets may form a PDU set.

A service flow of the multimedia service (such as the XRM service) usually includes a plurality of media types, such as audio, video, haptic, or other media types. As shown in FIG. 3, during transmission, to ensure QoS, service flows of different media types between a UE and an AS may be mapped to different QoS flows. The different QoS flows may have different delays during transmission, for example, a transmission delay between a RAN and a UPF. This may cause a problem that service data of different media types is not synchronized when a receiving end (for example, the UE) generates, based on received service flows of the plurality of media types, media content for playing.

Based on the foregoing problem, some embodiments provides a new service data flow (SDF) processing solution. A CN may generate, when a plurality of SDFs may meet a synchronization requirement, processing policy information of the plurality of SDFs; and based on the processing policy information, the plurality of SDFs can achieve transmission delays that are equal or have minimal differences, to solve a problem that played content is not synchronized because QoS flows obtained by mapping different SDFs have different delays or an excessively large delay difference, and facilitate improving user experience in multimedia services.

The following describes implementation details of the technical solution in some embodiments of this application in detail.

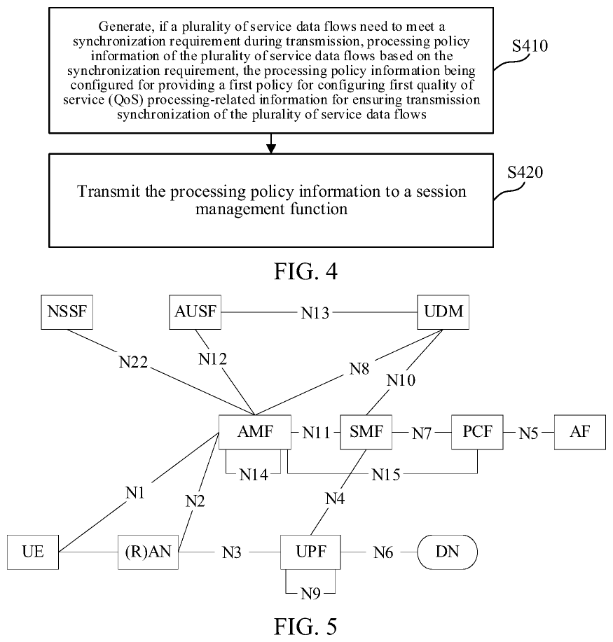

FIG. 4 is a flowchart of an SDF processing method according to some embodiments. The SDF processing method may be performed by a policy control function (PCF), or may be performed by another network element. Referring to FIG. 4, the SDF processing method may include operation S410 to operation S420.

Operation S410: Generate, if a plurality of SDFs may meet a synchronization requirement during transmission, processing policy information of the plurality of SDFs based on the synchronization requirement, the processing policy information being configured for providing a first policy for configuring first QoS processing-related information for ensuring transmission synchronization of the plurality of SDFs.

The SDF may be a group of packets, or one or more IP data flows. One or more IP data flows having the same source IP address, destination IP address, source port, destination port, and protocol ID may be designated as one SDF. The SDF may be an SDF of a multimedia service. The multimedia service may be, for example, a cloud gaming service, a VR service, an AR service, an MR service, an XR service, an XRM service, or a CR service. The SDF may be transmitted in a form of a service packet set (a PDU set). This is because if a single multimedia service frame or a GoP is encapsulated into a packet, the packet may have a large quantity of bytes. Therefore, the single multimedia service frame or the GoP may be split into a series of packets for carrying. There is a correlation between these series of packets. Therefore, these packets having correlation may be referred to as the PDU set. In another embodiment of this application, the SDF may alternatively be transmitted on a per-packet basis.

In some example embodiments, the plurality of SDFs may be SDFs of different media types. For example, the media types may include audio, video, haptic, or other media types. The SDFs of different media types may have different QoS requirement information, or may have the same QoS requirement information. During transmission, the plurality of SDFs may be mapped to the same QoS flow, or may be mapped to different QoS flows. For example, if the plurality of SDFs of different media types have different QoS requirement information, these SDFs of the different media types may be mapped to different QoS flows for transmission.

A cloud gaming service is used as an example. The cloud gaming service may include a first SDF of an audio type, a second SDF of a video type, a third SDF of a haptic type or another type, and the like. The SDFs of the three media types are associated with the same multimedia service. Therefore, during transmission, if the three SDFs are mapped to different QoS flows, these QoS flows have an association relationship. For example, there is a synchronization requirement among these QoS flows. The synchronization requirement means that delay information among the QoS flows is kept consistent or within a delay range. The plurality of SDFs associated with the same multimedia service may include one or more identifiers of the same service ID, the same session ID, the same UE address, and the like, or may be associated with the same description information.

In some example embodiments, an example in which the SDF processing method shown in FIG. 4 is performed by a PCF is used for description. The PCF may receive a synchronization requirement of a plurality of SDFs transmitted by an application function (AF). The synchronization requirement is configured for indicating that the plurality of SDFs may meet a synchronization requirement during transmission. Then, the PCF may generate processing policy information of the plurality of SDFs based on the synchronization requirement. In various embodiments of this application, the processing policy information of the plurality of SDFs may refer to processing policy information corresponding to the plurality of SDFs. There may be one or more pieces of processing policy information. One piece of processing policy information may be applied to one or more SDFs.

In some example embodiments, if it is determined that the plurality of SDFs are transmitted by using the same PDU session, it is determined that the plurality of SDFs may meet a synchronization requirement during transmission. For example, the PCF may alternatively use the plurality of SDFs transmitted by using the same PDU session as an SDF that may meet the synchronization requirement. In some embodiments, the PCF may identify the plurality of SDFs transmitted in the same PDU session as an SDF that has the synchronization requirement. The plurality of SDFs transmitted in the same PDU session may be determined by using an associated PDU session ID and/or a tunnel endpoint identifier (TEID).

In some example embodiments, when the processing policy information of the plurality of SDFs is generated, the processing policy information when the plurality of SDFs are mapped to different QoS flows for processing may be generated based on a synchronization requirement of the plurality of SDFs. The processing policy information is configured for indicating that the different QoS flows obtained by mapping the plurality of SDFs may meet the synchronization requirement. In other words, the plurality of SDFs may be mapped to different QoS flows, to obtain a plurality of QoS flows. The PCF may generate the processing policy information for the plurality of QoS flows. For example, one piece of processing policy information is generated for each of the plurality of QoS flows, or a quantity of the plurality of QoS flows is not in one-to-one correspondence with a quantity of processing policy information.

Still referring to FIG. 4, operation S420: Transmit the processing policy information to an SMF. The SMF configures, based on the processing policy information, QoS processing (or referred to as first QoS processing)-related information for a processing device of the plurality of SDFs.

In some example embodiments, a process in which the PCF transmits the processing policy information to the SMF may include: the PCF and the SMF interact with each other by using a session management (SM) policy association establishment signaling procedure or by using an SM policy association modification signaling procedure, and then the PCF transmits related processing policy information to the SMF by using an SM policy context data information element (IE).

In some example embodiments, an SDF processing device may include a UPF, a gNB device, and/or a UE. For example, the SMF may generate first N4 rules based on the processing policy information of the SDF, the first N4 rules including rules such as that a plurality of QoS flows may meet a synchronization requirement, and then transmit the first N4 rules to the UPF. The SMF may generate first QoS profiles based on the processing policy information of the SDF, the first QoS profiles including information specifying that a plurality of QoS flows may meet a synchronization requirement, and then transmit the first QoS profiles to the gNB. The SMF may generate first QoS rules based on the processing policy information of the SDF, the first QoS rules including rules such as that a plurality of QoS flows may meet a synchronization requirement, and then transmit the first QoS rules to the UE.

A 5G system is used as an example. FIG. 5 is an architecture of a key network element of a 5G network defined by an organization of the 3^{rd} generation partnership project (3GPP). In the 5G system, an access and mobility management function (AMF), an SMF, a UPF, a PCF, a network slice selection function (NSSF), an authentication server function (AUSF), a unified data management (UDM), and the like are CN elements of the 5G network. A UE may be a 5G terminal such as a mobile phone or a tablet computer. A (radio) access network ((R)AN) may be a 5G gNB. DN is a data network, that is, an AS accessed by a UE.

The AMF is responsible for terminating an N2 interface of a gNB control plane, and implementing encoding and decoding of a next generation application protocol (NGAP) based on a stream control transmission protocol (SCTP). The gNB and the AMF transmit the NGAP of an application layer by using the SCTP, and non-access stratum (NAS) signaling data of the UE is carried in the NGAP. The AMF is further responsible for terminating an N1 interface of the UE and implementing encryption and integrity protection of the NAS, is responsible for functions such as UE access authentication, authorization management, registration, connection, accessibility, and mobility management, and is responsible for transparent transmission of a session management message between the UE and the SMF.

In addition, the (R)AN interacts with the UPF via an N3 interface. The UPFs may interact with each other via an N9 interface. The UPF interacts with the SMF via an N4 interface. The UPF interacts with the DN via an N6 interface. The SMF interacts with the AMF via an N11 interface. The SMF interacts with the PCF via an N7 interface. The SMF interacts with the UDM via an N10 interface. The PCF interacts with an AF via an N5 interface. The AMFs may interact with each other via an N14 interface. The AMF interacts with the PCF via an N15 interface. The AMF interacts with the UDM via an N8 interface. The AMF interacts with the NSSF via an N22 interface. The AMF interacts with the AUSF via an N12 interface. The AUSF interacts with the UDM via an N13 interface.

Based on the system architecture shown in FIG. 5, the SMF may configure the generated first and other N4 rules to the UPF via the N4 interface, configure the first and other QoS profiles to the (R)AN via the AMF, and/or configure the first and other QoS rules to the UE through an AMF+NAS connection.

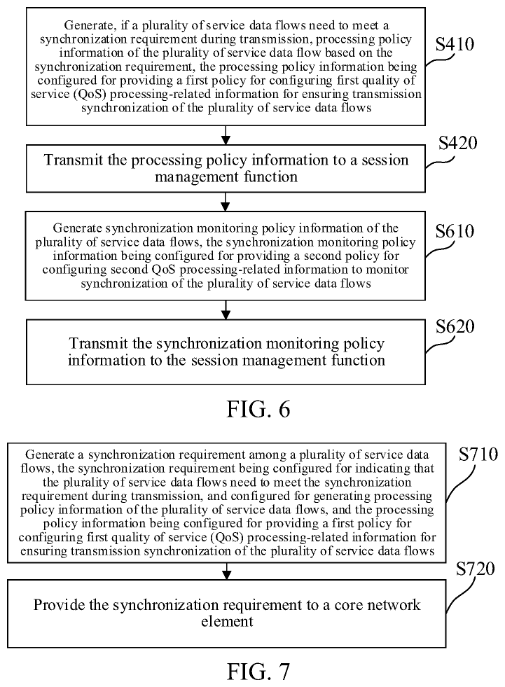

Based on the technical solution in the embodiment shown in FIG. 4, referring to FIG. 6, in some embodiments of this application, in addition to operation S410 and operation S420, the SDF processing method may further include operation S610 and operation S620.

Operation S610: Generate synchronization monitoring policy information of the plurality of SDFs, the synchronization monitoring policy information being configured for providing a second policy for configuring second QoS processing-related information to monitor synchronization of the plurality of SDFs. In various embodiments of this application, the synchronization monitoring policy information of the plurality of SDFs may refer to synchronization monitoring policy information corresponding to the plurality of SDFs. There may be one or more pieces of synchronization monitoring policy information. One piece of synchronization monitoring policy information may correspond to one or more SDFs.

In some example embodiments, the PCF may serve as a consumer for monitoring synchronization of an SDF or a QoS flow, and the PCF may generate, based on a requirement of the PCF, synchronization monitoring policy information corresponding to a plurality of SDFs. For example, if it is determined that the plurality of SDFs may meet a synchronization requirement during transmission, the PCF generates processing policy information of the plurality of SDFs based on the synchronization requirement. In some embodiments, the PCF may receive a synchronization monitoring requirement that is for the SDF and that is transmitted by the AF. The synchronization monitoring requirement is configured for indicating monitoring of transmission synchronization of the plurality of SDFs. Then, the PCF may generate, based on the synchronization monitoring requirement, synchronization monitoring policy information corresponding to the plurality of SDFs.

Operation S620: Transmit the synchronization monitoring policy information to the SMF. The SMF may configure QoS processing-related information for a processing device of the plurality of SDFs based on the synchronization monitoring policy information, to monitor synchronization of the plurality of SDFs.

In some example embodiments, a process in which the PCF transmits the synchronization monitoring policy information to the SMF may include: the PCF and the SMF interact with each other by using an SM policy association establishment signaling procedure or by using an SM policy association modification signaling procedure, and then the PCF transmits the synchronization monitoring policy information to the SMF by using an SM policy context data IE.

Similarly, an SDF processing device may include a UPF, a gNB device, and/or a UE. For example, the SMF may generate second N4 rules based on the synchronization monitoring policy information, the second N4 rules including information such as a synchronization monitoring requirement of a plurality of QoS flows, and then transmit the second N4 rules to the UPF. The SMF may generate second QoS profiles based on the synchronization monitoring policy information, the second QoS profiles including information such as a synchronization monitoring requirement of the plurality of QoS flows, and then transmit the second QoS profiles to the gNB. The SMF may generate third QoS rules based on the synchronization monitoring policy information, the third QoS rules including a synchronization monitoring requirement of the plurality of QoS flows and the like, and then transmit the third QoS rules to the UE.

In some example embodiments, after transmitting the monitoring policy information to the SMF, the PCF may further receive a synchronization monitoring result reported by an access network element (for example, a gNB), or may receive a synchronization monitoring result reported by another CN element. The synchronization monitoring result reported by the access network element may be a synchronization monitoring result of a Uu interface. For example, the another CN element may be a UPF, and then the synchronization monitoring result reported by the UPF may be a synchronization monitoring result of an N3 interface or an N9 interface.

In some example embodiments, the PCF may further adjust QoS parameter information of the SDF based on an end-to-end delay requirement and a synchronization requirement of the plurality of SDFs, and transmission delays of the plurality of SDFs inside the CN. The adjusted QoS parameter information of the SDF may be used as processing policy information of the SDF. For example, if the SDF is transmitted in a mode of a PDU set, one or more of parameters such as a PDU set delay budget (PSDB), a PDU set error rate (PSER), a maximum data burst volume (MDBV), and a packet delay variation (PDV) may be adjusted. When the SDF is transmitted in a per-packet mode, one or more of parameters such as a packet delay budget (PDB), a packet error rate (PER), and the MDBV may be adjusted.

PDB adjustment is used as an example for description. The PCF may adjust a PDB on an access network side, or may adjust a PDB on a CN side.

The technical solution in some embodiments of this application is described above from a perspective of the PCF, and implementation details of the technical solution in some embodiments of this application are described below from a perspective of an AF.

FIG. 7 is a flowchart of an SDF processing method according to some embodiments. The SDF processing method may be performed by an AF, or may be performed by another network element. Referring to FIG. 7, the SDF processing method may include operation S710 to operation S720.

Operation S710: Generate a synchronization requirement among a plurality of SDFs, the synchronization requirement being configured for indicating that the plurality of SDFs may meet a synchronization requirement during transmission. The synchronization requirement may further be configured for generating processing policy information of the plurality of SDFs. The processing policy information is configured for providing a first policy for configuring first QoS processing-related information for transmission synchronization of the plurality of SDFs.

For related descriptions of the plurality of SDFs, refer to the technical solutions in the foregoing embodiments, and details are not described herein again.

Operation S720: Provide the synchronization requirement to a CN element. The CN element may generate processing policy information of the plurality of SDFs based on the synchronization requirement. The processing policy information is configured for indicating that different QoS flows obtained by mapping the plurality of SDFs may meet the synchronization requirement.

A process in which the AF provides the synchronization requirement among the plurality of SDFs to the CN element may include: if the AF is trusted, the AF may directly transmit the synchronization requirement among the plurality of SDFs to the PCF; or if the AF is untrusted, the AF may transmit the synchronization requirement among the plurality of SDFs to a NEF, and then the NEF forwards the synchronization requirement to the PCF. In various embodiments of this application, whether the AF is trusted or untrusted is defined with respect to the PCF.

For related descriptions that the CN element generates processing policy information of the plurality of SDFs based on the synchronization demand, refer to the technical solutions in the foregoing embodiments, and details are not described herein again.

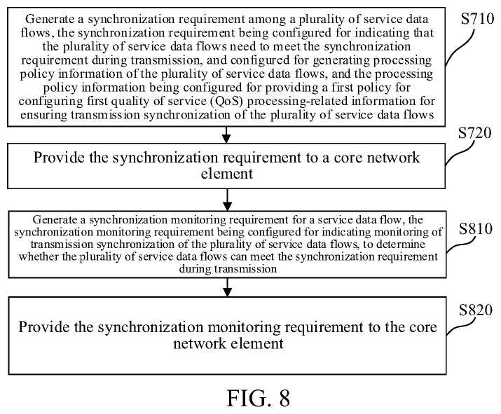

Based on the technical solution in the embodiment shown in FIG. 7, referring to FIG. 8, in some embodiments of this application, in addition to operation S710 and operation S720, the SDF processing method may further include operation S810 and operation S820.

Operation S810: Generate a synchronization monitoring requirement for an SDF.

The synchronization monitoring requirement is configured for indicating monitoring of transmission synchronization of a plurality of SDFs, to determine whether the plurality of SDFs can meet the synchronization requirement during transmission.

Operation S820: Provide the synchronization monitoring requirement to the CN element. The CN element may generate, based on the synchronization monitoring requirement, synchronization monitoring policy information corresponding to the plurality of SDFs.

A process in which the AF provides the synchronization monitoring requirement to the CN element may include: if the AF is trusted, the AF may directly transmit the synchronization monitoring requirement to the PCF; or if the AF is untrusted, the AF may transmit the synchronization monitoring requirement to a NEF, and then the NEF forwards the synchronization monitoring requirement to the PCF.

For related descriptions that the CN element generates, based on the synchronization monitoring requirement, the synchronization monitoring policy information corresponding to the plurality of SDFs, refer to the technical solutions in the foregoing embodiments, and details are not described herein again.

In some example embodiments, after providing the synchronization monitoring requirement to the CN element, the AF may further receive a synchronization monitoring result reported by an access network element (for example, a gNB), or may receive a synchronization monitoring result reported by another CN element. For example, the synchronization monitoring result reported by the access network element may be a synchronization monitoring result of a Uu interface. If the another CN element may be, for example, a UPF, the synchronization monitoring result reported by the UPF may be a synchronization monitoring result of an N3 interface or an N9 interface.

According to the technical solution in some embodiments of this application, the CN element may generate, when the plurality of SDFs may meet the synchronization requirement, the processing policy information of the plurality of service data flows; and based on the processing policy information, the plurality of SDFs can achieve transmission delays that are equal or have minimal differences, to solve a problem that played content is not synchronized because QoS flows obtained by mapping different SDFs have different delays or an excessively large delay difference, and facilitate improving user experience in multimedia services.

The following describes implementation details of the technical solutions in some embodiments of this application in detail below again by using an example in which the 5G system processes an XRM service.

In some embodiments of this application, the CN element may generate PCC rules (processing policy information) based on a synchronization requirement among a plurality of QoS flows, and monitor synchronization between different QoS flows to meet the synchronization requirement of the plurality of QoS flows. The PCC rules generated in a PDU session establishment phase include the synchronization requirement of the plurality of QoS flows. The requirement may be separately indicated. For example, the synchronization requirement is indicated by an AF. Certainly, it may be default that the synchronization requirement may be met between XRM service flows in a PDU session. In this case, the requirement does not may be indicated separately. Then, corresponding processing is performed on a corresponding control plane network element, a UPF, and an NG-RAN according to the PCC rules.

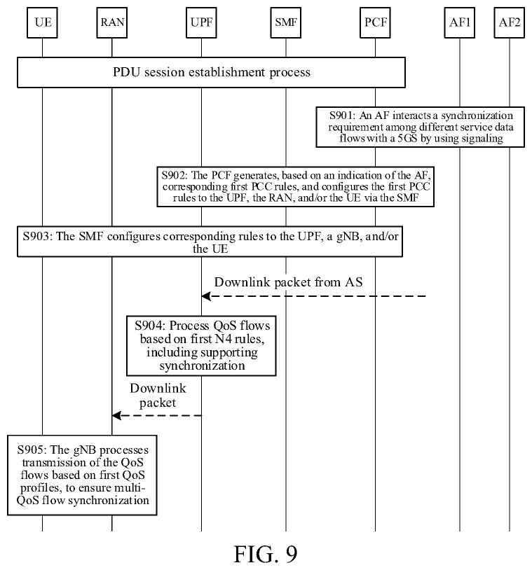

With reference to FIG. 9, the technical solution in some embodiments of this application is described in detail by using a example, including the following operations:

Operation S901: After establishing a PDU session (for example, a UE establishes the PDU session by using a RAN, a UPF, an SMF, or a PCF), an AF (which may be one AF or a plurality of AFs) interacts a synchronization requirement or a synchronization demand among a plurality of (different) SDFs with a 5G system (5GS) by using signaling. By using this operation, the AF may provide the synchronization requirement or the synchronization requirement to the CN element. The plurality of SDFs include the same PDU session and SDFs between different PDU sessions. For example, the synchronization requirement or the synchronization demand among the plurality of SDFs may alternatively be acquired in an implicit mode. For example, a plurality of SDFs (for example, two or more) in the same PDU session is considered as needing to meet the synchronization requirement.

Operation S902: The PCF generates, according to an indication of the AF, corresponding first PCC rules. The PCF generates the first PCC rules of the plurality of SDFs based on the synchronization requirement of the plurality of SDFs interacted with (indicated by) the AF. These first PCC rules include the synchronization requirement for a plurality of QoS flows, and the plurality of QoS flows are obtained by mapping the plurality of SDFs. In this operation, if it is determined that the plurality of SDFs may meet the synchronization requirement during transmission, the PCF generates processing policy information (the first PCC rules) of the plurality of SDFs based on the synchronization requirement. Then, the PCF may separately configure corresponding rule information for the UPF, the RAN, and/or the UE to the UPF, the RAN, and/or the UE by using the SMF.

Operation S903: A 5G core network (5GC) configures the first PCC rules supporting multi-QoS flow synchronization transmission to the UPF, the RAN and/or a UE end. Specifically, after generating the first PCC rules in operation S902, the PCF may transmit the first PCC rules to the SMF. The SMF configures first N4 rules generated with reference to the first PCC rules to the UPF, configures first QoS profiles to an NG-RAN, and/or configures the first QoS rules to the UE.

Operation S904: When a downlink packet from an AS arrives at the UPF, the UPF processes data of the plurality of QoS flows according to the first N4 rules, including supporting/processing synchronization of the plurality of QoS flows.

Operation S905: A gNB processes transmission of the plurality of QoS flows according to first QoS profiles, to ensure a synchronization requirement of the plurality of QoS flows. The synchronization on a gNB side means that a difference between transmission delays of data of corresponding QoS flows at the Uu interface is within a range, or is completely the same.

In some example embodiments, after the PDU session is established, a segmented delay between the UPF and the NG-RAN, and a segmented delay between the NG-RAN and the UE may be monitored by using a QoS monitoring mechanism, and then synchronization of the plurality of QoS flows is confirmed by using QoS monitoring. If the plurality of QoS flows are not synchronized, one or more QoS parameters, such as PDB or PSDB, of the plurality of QoS flows may be adjusted to meet the synchronization requirement of the plurality of QoS flows.

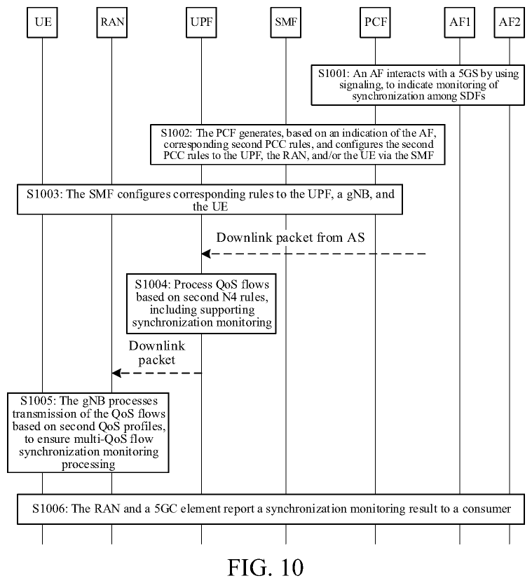

Specifically, as shown in FIG. 10, the following operations are included:

Operation S1001: An AF (which may be one AF or a plurality of AFs) interacts with a 5GS by using signaling, to indicate monitoring of synchronization among a plurality of different SDFs. In this operation, the AF may generate a synchronization monitoring requirement for the plurality of SDFs, the synchronization monitoring requirement being configured for indicating monitoring of the transmission synchronization of the plurality of SDFs, to determine whether the plurality of SDFs can meet the synchronization requirement during transmission, and provide the synchronization monitoring requirement to the CN element of the 5GS.

Operation S1002: The PCF generates, according to an indication of the AF, corresponding second PCC rules, these second PCC rules including a synchronization monitoring requirement of a plurality of QoS flows, and the plurality of QoS flows being obtained by mapping the plurality of SDFs, and then configures corresponding rule information to the UPF, the RAN, and/or the UE by using an SMF.

Operation S1003: The 5GC configures second policy information supporting multi-QoS flow synchronization monitoring to the UPF, the RAN, and/or a UE end. Specifically, the PCF generates the second PCC rules, and transmits the second PCC rules to the SMF. The SMF configures second N4 rules generated with reference to the second PCC rules to the UPF, configures the second QoS profiles to the NG-RAN, and/or configures the second QoS rules to the UE.

Operation S1004: The UPF processes, when a downlink packet from an AS arrives at the UPF, data of the plurality of QoS flows according to second N4 rules, including supporting synchronization monitoring of the plurality of QoS flows.

Operation S1005: A gNB processes transmission of the plurality of QoS flows according to second QoS profiles, to ensure a synchronization monitoring requirement of the plurality of QoS flows, where the synchronization on a gNB side means that a difference between transmission delays of data of corresponding QoS flows at the Uu interface is within a range, or is completely the same.

Operation S1006: The RAN and a 5GC element report a synchronization monitoring result of the plurality of QoS flows to a corresponding consumer network element. The consumer network element may be, for example, the AF, the PCF, or may be another network element.

In some embodiments, the PCF may adjust a QoS parameter, for example, adjust a PSDB or a PDB, based on a delay of an N6 interface (that is, between the DN/AS and the UPF) and an end-to-end delay and a synchronization requirement of the SDF. Adjusting the PDB is used as an example for description. The PCF may adjust a PDB on an access network side (that is, an AN-PDB), or may adjust a PDB on a CN side (that is, a CN-PDB).

For example, if an end-to-end delay requirement of an SDF is T0 ms, and a delay at the N6 interface is actually T1 ms, a total delay inside the 5GC is to be less than T0−T1, and a delay jitter is to be limited within a range.

In conclusion, in the technical solution in some embodiments of this application, a problem that playback synchronization of a multimedia service at a receiving end is affected due to different delays in transmission of the plurality of QoS flows in a mobile communication network such as 5G/6G after a multimedia service flow is mapped into a plurality of QoS flows can be solved from an end-to-end perspective, and processing load on an NG-RAN base station can be reduced. In addition, in this solution, a delay variation on the N6 interface may further be combined, whereby a policy generated by the PCF can compensate for the delay variation on the N6 interface inside the 5GS, and a change of a real-time transmission condition of an end-to-end multimedia service can be adapted better.

The technical solution in some embodiments of this application is not only applicable to the 5G system, but also applicable to a future evolved mobile communication system. In addition, the technical solution in some embodiments of this application is not only applicable to an XRM service, but also applicable to processing of another multimedia service flow.

The following describes an apparatus embodiment of this application, which may be configured to perform the SDF processing method in the foregoing embodiments of this application. For details not disclosed in the apparatus embodiment of this application, please refer to the embodiment of the foregoing SDF processing method of this application.

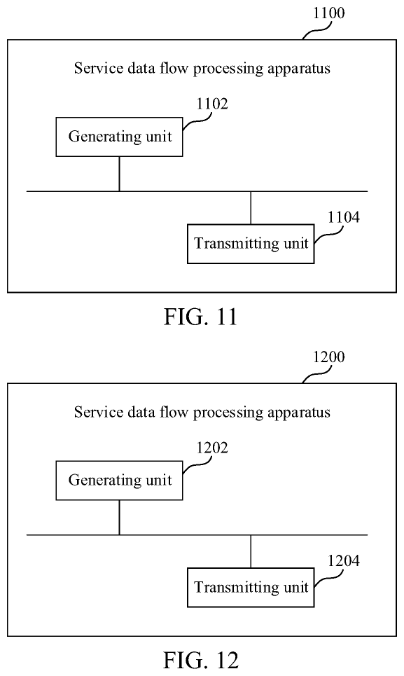

FIG. 11 is a block diagram of an SDF processing apparatus according to some embodiments. The SDF processing apparatus may be applied to a PCF, or may be applied to another network element.

Referring to FIG. 11, an SDF processing apparatus 1100 according to some embodiments includes a generating unit 1102 and a transmitting unit 1104.

The generating unit 1102 is configured to generate, if a plurality of SDFs may meet a synchronization requirement during transmission, processing policy information of the plurality of SDFs based on the synchronization requirement, the processing policy information being configured for providing a first policy for configuring first QoS processing-related information for transmission synchronization of the plurality of SDFs. The transmitting unit 1104 is configured to transmit the processing policy information to an SMF, to enable the SMF to configure QoS processing-related information for a processing device of the plurality of SDFs based on the processing policy information.

In some embodiments, based on the foregoing solution, the generating unit 1102 is further configured to: receive the synchronization requirement of the plurality of SDFs transmitted by an AF, the synchronization requirement being configured for indicating that the plurality of SDFs may meet the synchronization requirement during transmission; and determine, based on the synchronization requirement, that the plurality of SDFs may meet the synchronization requirement during transmission.

In some embodiments, based on the foregoing solution, the generating unit 1102 is further configured to use the plurality of SDFs transmitted by using the same PDU session as an SDF that may meet the synchronization requirement; and determine, if it is determined that the plurality of SDFs are transmitted by using the same PDU session, that the plurality of SDFs may meet the synchronization requirement during transmission.

In some embodiments, based on the foregoing solution, the generating unit 1102 is configured to generate, based on the synchronization requirement, the processing policy information of the plurality of SDFs when mapped to different QoS flows for processing, the processing policy information being configured for indicating that the different QoS flows obtained by mapping the plurality of SDFs may meet the synchronization requirement.

In some embodiments, based on the foregoing solution, the generating unit 1102 is further configured to: generate synchronization monitoring policy information corresponding to the plurality of SDFs, the synchronization monitoring policy information being configured for providing a second policy for configuring second QoS processing-related information to monitor synchronization of the plurality of SDFs. The transmitting unit 1104 is further configured to: transmit the synchronization monitoring policy information to the SMF, to enable the SMF to configure QoS processing-related information for a processing device of the plurality of SDFs based on the synchronization monitoring policy information, to monitor synchronization of the plurality of SDFs.

In some embodiments, based on the foregoing solution, the generating unit 1102 is configured to: receive a synchronization monitoring requirement that is for the SDF and that is transmitted by the application function, and generate the synchronization monitoring policy information corresponding to the plurality of SDFs based on the synchronization monitoring requirement.

In some embodiments, based on the foregoing solution, the SDF processing apparatus 1100 further includes: a receiving unit, configured to perform at least one of the following processes after transmitting the monitoring policy information to the SMF: receiving a synchronization monitoring result reported by the access network element; and receiving a synchronization monitoring result reported by another CN element.

In some embodiments, based on the foregoing solution, the SDF processing apparatus 1100 further includes: a processing unit, configured to adjust QoS parameters of the plurality of SDFs based on the synchronization requirement and an end-to-end delay requirement of the plurality of SDFs and transmission delays of the plurality of SDFs in a CN.

FIG. 12 is a block diagram of an SDF processing apparatus according to some embodiments. The SDF processing apparatus may be applied to an AF, or may be applied to another network element.

Referring to FIG. 12, an SDF processing apparatus 1200 according to some embodiments includes a generating unit 1202 and a transmitting unit 1204.

The generating unit 1202 is configured to generate a synchronization requirement among a plurality of SDFs, the synchronization requirement being configured for indicating that the plurality of SDFs may meet a synchronization requirement during transmission, and being configured for generating processing policy information of the plurality of SDFs, and the processing policy information being configured for providing a first policy for configuring first QoS processing-related information for transmission synchronization of the plurality of SDFs. The transmitting unit 1204 is configured to provide the synchronization requirement to a CN element, to enable the CN element to generate processing policy information of the plurality of SDFs based on the synchronization requirement, the processing policy information being configured for indicating that different QoS flows obtained by mapping the plurality of SDFs may meet the synchronization requirement.

In some embodiments, based on the foregoing solution, the generating unit 1202 is further configured to: generate a synchronization monitoring requirement for the plurality of SDFs, the synchronization monitoring requirement being configured for indicating monitoring of transmission synchronization of the plurality of SDFs, to determine whether the plurality of SDFs can meet a synchronization requirement during transmission. The transmitting unit 1204 is further configured to: provide the synchronization monitoring requirement to a CN element, to enable the CN element to generate, based on the synchronization monitoring requirement, synchronization monitoring policy information corresponding to the plurality of SDFs.

In some embodiments, based on the foregoing solution, the SDF processing apparatus 1200 further includes: a receiving unit, configured to perform at least one of the following processes after providing the synchronization monitoring requirement to the CN element: receiving a synchronization monitoring result reported by the access network element; and receiving a synchronization monitoring result reported by another CN element.

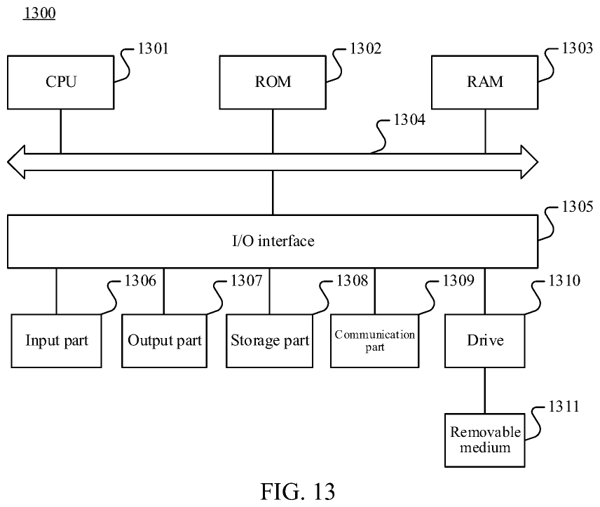

FIG. 13 is a schematic structural diagram of a computer system suitable for implementing an electronic device according to some embodiments. The electronic device may be the PCF or the AF in the foregoing embodiments.

The computer system 1300 of the electronic device shown in FIG. 13 is merely an example, and does not constitute any limitation on the function and scope of use of the embodiments of this application.

As shown in FIG. 13, the computer system 1300 may include a central processing unit (CPU) 1301, which may perform various suitable actions and processing based on a program stored in a read-only memory (ROM) 1302 or a program loaded from a storage part 1308 into a random access memory (RAM) 1303, for example, perform the method in the foregoing embodiments. The RAM 1303 further has various programs and data for system operations stored therein. The CPU 1301, the ROM 1302, and the RAM 1303 are connected to each other through a bus 1304. An input/output (I/O) interface 1305 is connected to the bus 1304.

The following components may be connected to the I/O interface 1305: an input part 1306 including a keyboard, a mouse, and the like; an output part 1307 including a cathode ray tube (CRT), a liquid crystal display (LCD), a speaker, and the like; a storage part 1308 including a hard disc; and a communication part 1309 including a network interface card such as a local area network (LAN) card or a modem. The communication part 1309 performs communication processing by using a network such as the Internet. A drive 1310 is connected to the I/O interface 1305 as required. A removable medium 1311 such as a magnetic disc, an optical disc, a magneto-optical disc, or a semiconductor memory is installed on the drive 1310 as required, to facilitate installing a computer program read from the removable medium into the storage part 1308 as required.

Particularly, according to the embodiments of this application, the process described with reference to the flowchart may be implemented as a computer software program. For example, some embodiments includes a computer program product, the computer program product including a computer program carried on a computer-readable storage medium, and the computer program being configured for performing the methods shown in the flowcharts. In such some embodiments, the computer program may be downloaded and installed from a network by using the communication part 1309, or installed from the removable medium 1311. When the computer program is executed by the CPU 1301, various functions defined in the system of this application are performed.

The computer-readable storage medium described in the embodiments of this application may be a computer-readable signal medium, or a computer-readable storage medium, or a combination thereof. The computer-readable storage medium may be, for example, but is not limited to, a system, an apparatus, or a device of electricity, magnetism, optics, electromagnetism, infrared, or semi-conductors, or any combination thereof. More examples of the computer-readable storage medium may include, but are not limited to, an electrical connection having one or more wires, a portable computer disc, a hard disc, a RAM, a ROM, an erasable programmable ROM (EPROM), a flash memory, an optical fiber, a portable compact disc ROM (CD-ROM), an optical storage device, a magnetic storage device, or any appropriate combination of the above. In some embodiments, the computer-readable storage medium may be any tangible medium including or storing a computer program. The computer program may be used by or in combination with an instruction execution system, apparatus, or device. In some embodiments, a computer-readable signal medium may include a data signal being propagated in a baseband or as part of a carrier wave, and carries a computer-readable computer program. The data signal propagated in such a way may adopt a plurality of forms, including, but not limited to, an electromagnetic signal, an optical signal, or any appropriate combination thereof. The computer-readable signal medium may further be any computer-readable medium other than the computer-readable storage medium. The computer-readable medium may transmit, propagate, or transmit a program used by or in combination with an instruction execution system, apparatus, or device. The computer program included in the computer-readable medium may be transmitted by using any suitable medium, including, but not limited to: a wireless medium, a wired medium, or a combination thereof.

The flowcharts and block diagrams in the accompanying drawings illustrate possible system architectures, functions and operations that may be implemented by a system, a method, and a computer program product according to various embodiments of this application. Each box in the flowchart or the block diagram may represent a module, a program segment, or a part of code. The module, the program segment, or the part of the code includes one or more executable instructions for implementing a specified logical function. In some alternative implementations, functions annotated in the boxes may alternatively occur a different order from those annotated in the accompanying drawings. For example, two boxes shown consecutively may actually be performed basically in parallel, and sometimes the two blocks may be performed in reverse order. This depends on the functions involved. Each box of the block diagrams or the flowcharts and combinations of boxes in the block diagrams or the flowcharts may be implemented by a dedicated hardware-based system that performs specified functions or operations, or may be implemented by a combination of dedicated hardware and a computer program.

Units involved in the embodiments described in this application may be implemented in a software mode, or may be implemented in a hardware mode, or the described units may be disposed in a processor. Names of these units do not constitute a limitation on the units in a case.

As another aspect, this application further provides a computer-readable medium. The computer-readable medium may be included in the electronic device described in the foregoing embodiments, may exist alone, and is not assembled into the electronic device. The foregoing computer-readable medium carries one or more computer programs, and when the one or more computer programs are executed by the electronic device, the electronic device implements the methods described in the foregoing embodiments.

Although a plurality of modules or units of a device configured to perform actions are mentioned in the foregoing detailed description, such division is not mandatory. Actually, according to the implementations of this application, features and functions of the two or more modules or units described above may be embodied in one module or unit. On the contrary, the features and functions of one module or unit described above may further be divided to be embodied by a plurality of modules or units.

Through the foregoing descriptions of the implementations, a person skilled in the art may readily understand that the exemplary implementations described herein may be implemented by software, or may be implemented by combining software with necessary hardware. Therefore, the technical solutions according to the implementations of this application may be embodied in a form of a software product. The software product may be stored in a non-volatile storage medium (which may be a CD-ROM, a USB flash drive, a removable hard disc, or the like) or on the network, including several instructions for enabling an electronic device to perform the method according to the implementations of this application.

For example, the electronic device may be a PCF, and then the PCF may perform the SDF processing method shown in FIG. 4 and FIG. 6. For another example, the electronic device may be an AF, and the AF may perform the SDF processing method shown in FIG. 7 and FIG. 8.

A person skilled in the art can easily figure out other implementation solutions of this application after considering the description and practicing the implementations disclosed herein. This application is intended to cover any variations, usages, or adaptive changes of this application. These variations, usages, or adaptive changes follow the general principles of this application and include common general knowledge or common technical means in the technical field not disclosed in this application.

This application is not limited to the precise structures described above and shown in the accompanying drawings, and various modifications and changes may be made without departing from the scope of this application. The scope of this application is subject only to the appended claims.

What is claimed is:

1. A service data flow processing method, performed by an electronic device, and the method comprising:
determining that a plurality of service data flows are to meet a synchronization requirement during transmission, wherein the synchronization requirement specifies that transmission delays of the plurality of service data flows are kept within a delay range;
generating, based on the synchronization requirement, processing policy information corresponding to the plurality of service data flows, wherein the processing policy information provides a first policy for configuring first quality of service (QoS) processing-related information for transmission synchronization of the plurality of service data flows; and
transmitting the processing policy information to a session management entity, to cause the session management entity to configure, based on the processing policy information, the first QoS processing-related information at a processing device of the plurality of service data flows.

2. The method according to claim 1, wherein the determining that the plurality of service data flows are to meet the synchronization requirement during transmission comprises:
receiving the synchronization requirement from an application entity; and
determining, based on the received synchronization requirement, that the plurality of service data flows are to meet the synchronization requirement during transmission.

3. The method according to claim 1, wherein the determining that the plurality of service data flows are to meet the synchronization requirement during transmission comprises:
determining, based on the plurality of service data flows being transmitted via a single protocol data unit (PDU) session, that the plurality of service data flows are to meet the synchronization requirement during transmission.

4. The method according to claim 1, wherein the generating comprises:
generating the processing policy information when the plurality of service data flows are mapped to a plurality of QoS flows, wherein the processing policy information indicates that the plurality of QoS flows mapped from the plurality of service data flows are to meet the synchronization requirement.

5. The method according to claim 1, further comprising:
generating synchronization monitoring policy information corresponding to the plurality of service data flows, wherein the synchronization monitoring policy information provides a second policy for configuring second QoS processing-related information, and wherein the second QoS processing-related information is for monitoring synchronization of the plurality of service data flows; and
transmitting the synchronization monitoring policy information to the session management entity.

6. The method according to claim 5, wherein the generating synchronization monitoring policy information comprises:
receiving, from an application entity, a synchronization monitoring requirement for the plurality of service data flows, and generating the synchronization monitoring policy information based on the synchronization monitoring requirement.

7. The method according to claim 5, wherein after the transmitting the synchronization monitoring policy information to the session management entity, the method further comprises at least one of the following operations:
receiving a synchronization monitoring result reported by an access network element; and
receiving a synchronization monitoring result reported by a core network element.

8. The method according to claim 1, further comprising:
adjusting QoS parameters of the plurality of service data flows based on the synchronization requirement, an end-to-end delay requirement of the plurality of service data flows, and transmission delays of the plurality of service data flows in a core network.

9. A service data flow processing method, performed by an electronic device, and the method comprising:
generating a synchronization requirement among a plurality of service data flows, wherein the synchronization requirement specifies that transmission delays of the plurality of service data flows are kept within a delay range; and
providing the synchronization requirement to a core network element, to cause the core network element to generate, based on the synchronization requirement, processing policy information corresponding to the plurality of service data flows, wherein the processing policy information provides a first policy for configuring first quality of service (QoS) processing-related information, and wherein the first QoS processing-related information is for synchronizing transmission of the plurality of service data flows.

10. The method according to claim 9, further comprising:
generating a synchronization monitoring requirement for the plurality of service data flows, wherein the synchronization monitoring requirement indicates monitoring of transmission synchronization of the plurality of service data flows, to determine whether the plurality of service data flows meet the synchronization requirement during transmission; and
providing the synchronization monitoring requirement to the core network element, to cause the core network element to generate, based on the synchronization monitoring requirement, synchronization monitoring policy information corresponding to the plurality of service data flows.

11. A service data flow processing apparatus, comprising:
at least one memory configured to store program code; and
at least one processor configured to read the program code and operate as instructed by the program code, the program code comprising:
determining code configured to cause at least one of the at least one processor to determine that a plurality of service data flows are to meet a synchronization requirement during transmission, wherein the synchronization requirement specifies that transmission delays of the plurality of service data flows are kept within a delay range;
generating code configured to cause at least one of the at least one processor to generate, based on the synchronization requirement, processing policy information corresponding to the plurality of service data flows, wherein the processing policy information provides a first policy for configuring first quality of service (QoS) processing-related information for transmission synchronization of the plurality of service data flows; and
transmitting code configured to cause at least one of the at least one processor to transmit the processing policy information to a session management entity, to cause the session management entity to configure, based on the processing policy information, the first QoS processing-related information at a processing device of the plurality of service data flows.

12. The apparatus according to claim 11, wherein the determining code is further configured to cause at least one of the at least one processor to:
receive the synchronization requirement from an application entity; and
determine, based on the received synchronization requirement, that the plurality of service data flows are to meet the synchronization requirement during transmission.

13. The apparatus according to claim 11, wherein the determining code is further configured to cause at least one of the at least one processor to:
determine, based on the plurality of service data flows being transmitted via a single protocol data unit (PDU) session, that the plurality of service data flows are to meet the synchronization requirement during transmission.

14. The apparatus according to claim 11, wherein the generating code is further configured to cause at least one of the at least one processor to:
generate the processing policy information when the plurality of service data flows are mapped to a plurality of QoS flows, wherein the processing policy information indicates that the plurality of QoS flows mapped from the plurality of service data flows are to meet the synchronization requirement.

15. The apparatus according to claim 11, wherein the program code further comprises:
monitoring code configured to cause at least one of the at least one processor to generate synchronization monitoring policy information corresponding to the plurality of service data flows, wherein the synchronization monitoring policy information provides a second policy for configuring second QoS processing-related information, and wherein the second QoS processing-related information is for monitoring synchronization of the plurality of service data flows; and
wherein the transmitting code is further configured to cause at least one of the at least one processor to transmit the synchronization monitoring policy information to the session management entity.

16. The apparatus according to claim 15, wherein the monitoring code is further configured to cause at least one of the at least one processor to:
receive, from an application entity, a synchronization monitoring requirement for the plurality of service data flows, and generate the synchronization monitoring policy information based on the synchronization monitoring requirement.

17. The apparatus according to claim 15, wherein the program code further comprises:
receiving code configured to cause at least one of the at least one processor to perform at least one of the following operations:
receive a synchronization monitoring result reported by an access network element; and
receive a synchronization monitoring result reported by a core network element.

18. The apparatus according to claim 11, wherein the program code further comprises:
adjustment code configured to cause at least one of the at least one processor to adjust QoS parameters of the plurality of service data flows based on the synchronization requirement, an end-to-end delay requirement of the plurality of service data flows, and transmission delays of the plurality of service data flows in a core network.
